(19) United States
(12) Patent Application Publication
(10) Pub. No.: US 2014/0354633 A1
(43) Pub. Date: Dec. 4, 2014

(54) IMAGE PROCESSING METHOD AND IMAGE PROCESSING DEVICE

(71) Applicant: Huawei Technologies Co., Ltd., Shenzhen (CN)

(72) Inventors: Jie ZHANG, Shenzhen (CN); Lianggang YU, Shenzhen (CN)

(21) Appl. No.: 14/462,082

(22) Filed: Aug. 18, 2014

Related U.S. Application Data
(63) Continuation of application No. PCT/CN2012/085329, filed on Nov. 27, 2012.

(30) Foreign Application Priority Data
Feb. 24, 2012 (CN) 201210043466.0

(51) Int. Cl. G06T 19/20; G06T 15/00; G06T 11/60

(52) U.S. Cl. CPC G06T 19/20; G06T 11/60; G06T 15/005; G06T 2200/24; G06T 2200/32
USPC 345/419

(57) ABSTRACT

The embodiments of the present invention provide an image processing method and image processing device. The method includes: determining a UI element of a 2D layer and a UI element of a 3D layer in a user scene; performing rendering processing on the UI element of the 2D layer to acquire a data source for the UI element of the 2D layer, and performing rendering processing on the UI element of the 3D layer to acquire a data source for the UI element of the 3D layer; and combining the data source for the UI element of the 2D layer and the data source for the UI element of the 3D layer, to acquire a 2D and 3D fused data source. In the embodiments of the present invention, the efficiency of rendering processing can be improved.

### CROSS-REFERENCE TO RELATED APPLICATIONS

This application is a continuation of International Patent Application No. PCT/CN2012/085329 filed on Nov. 27, 2012, which claims priority to Chinese Patent Application No. No. 201210043466.0, filed on Feb. 24, 2012, both of which are hereby incorporated by reference in their entireties.

### TECHNICAL FIELD

The embodiments of the present invention relates to image application technologies, and particularly, to an image processing method and image processing device.

### BACKGROUND

A Two-dimensional (2D) and Three-dimensional (3D) fused scene is a commonly used display scene for a terminal, which may be applied to advertisements, movies on demand, visual chat, etc.

At present, a commonly used technology for realizing the 2D and 3D fused scene is to perform rendering processing on inputted contents, to generate a 3D data source uniformly, and the 2D part in the scene can be acquired only through a simulation of a corresponding 3D part. For example, a model of the corresponding 3D part is placed in a plane of z=0 as a whole to simulate a 2D display effect, thus resulting in low efficiency of rendering processing.

### SUMMARY

The embodiments of the present invention provide an image processing method and image processing device, which can improve the efficiency of rendering processing.

In one aspect, an image processing method is provided, including: determining a User Interface (UI) element of a 2D layer and a UI element of a 3D layer in a user scene; performing rendering processing on the UI element of the 2D layer to acquire a data source for the UI element of the 2D layer, and performing rendering processing on the UI element of the 3D layer to acquire a data source for the UI element of the 3D layer; and combining the data source for the UI element of the 2D layer and the data source for the UI element of the 3D layer to acquire a 2D and 3D fused data source.

In another aspect, an image processing device is provided, including: a determining unit, configured to determine a UI element of a 2D layer and a UI element of a 3D layer in a user scene; a rendering unit, configured to perform rendering processing on the UI element of the 2D layer to acquire a data source for the UI element of the 2D layer, and perform rendering processing on the UI element of the 3D layer to acquire a data source for the UI element of the 3D layer; and a combining unit, configured to combine the data source for the UI element of the 2D layer and the data source for the UI element of the 3D layer to acquire a 2D and 3D fused data source.

In the embodiments of the present invention, the efficiency of rendering processing can be improved by acquiring a data source for a UI element of a 2D layer and a data source for a UI element of a 3D layer separately, and then acquiring a 2D and 3D fused data source.

### BRIEF DESCRIPTION OF DRAWINGS

To illustrate the technical solutions in the embodiments of the present invention more clearly, a brief introduction on the accompanying drawings which are needed in the description of the embodiments or the prior art is given below. Apparently, the accompanying drawings in the description below are merely some of the embodiments of the present invention, based on which other drawings can be acquired by the persons of ordinary skill in the art without any inventive effort.

FIG. 1 is a schematic flowchart of an image processing method according to an embodiment of the present invention;

FIG. 2 is a schematic flowchart of a process of an image processing method according to an embodiment of the present invention; and

FIG. 3 is a block diagram of a structure of an image processing device according to an embodiment of the present invention.

### DESCRIPTION OF EMBODIMENTS

The technical solutions in the embodiments of the present invention will be described clearly and completely hereinafter with reference to the accompanying drawings in the embodiments of the present invention. Evidently, the described embodiments are merely part, but not all, of the embodiments of the present invention. All other embodiments, which can be derived by persons of ordinary skills in the art based on the embodiments of the present invention without any inventive efforts, shall fall into the protection scope of the present invention.

It should be understood that, in the embodiments of the present invention, a 2D and 3D fused scene means that a 2D display scene and a 3D display scene exist simultaneously in a same display scene. For example, in a 2D and 3D fused advertisement, a picture in the advertisement may be displayed in 3D and a word may be displayed in 2D. In a 2D and 3D fused video, an image in the video may be displayed in 3D, and a word may be displayed in 2D. It should be noted that, in the embodiments of the present invention, the 3D display scene may be an auto-stereoscopic 3D display scene, the primary principle of which is to form the scene by employing user's binocular parallax. For a stereo image, the result viewed by the user's left eye and that viewed by the user's right eye are different, and if the image seen by the user's left eye and that seen by the user's right eye are transferred to the user's brain with a same frequency, the brain may reconstruct a real 3D image in a physical space according to the images of the left eye and the right eye.

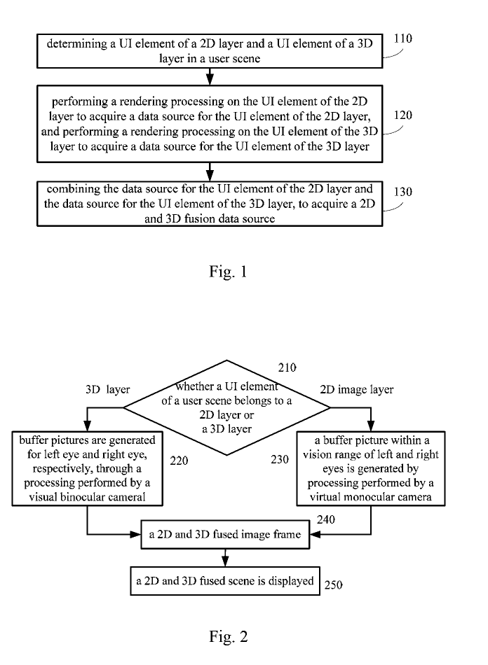

FIG. 1 is a schematic flowchart of an image processing method of an embodiment of the present invention. The method shown in FIG. 1 may be performed by an image processing device.

110. A user interface (User Interface, UI) element of a 2D layer and a UI element of a 3D layer in a user scene are determined.

Alternatively, as an embodiment, the image processing device may determine the UI element of the 2D layer and the UI element of the 3D layer in the user scene according to tag information, wherein the tag information may be used for indicating whether a UI element in the user scene belongs to the 2D layer or the 3D layer. It should be understood that, in an embodiment of the present invention, the image processing device may also determine the UI element of the 2D layer and the UI element of the 3D layer in the user scene according to other indication information capable of distinguishing between UI elements. This is not limited by the embodiments of the present invention.

Alternatively, as another embodiment, the tag information may be a configuration file, or may be attribute information in an Extensible Markup Language (Extensible Markup Language, XML)/Hypertext Markup Language (Hypertext Markup Language, HTML) file for describing a UI element. In an embodiment of the present invention, the tag information may also be any other information which may be used for indicating whether a UI element in a user scene belongs to a 2D layer or a 3D layer. For example, the tag information may be number “0” and number “1”, and, for example, the number “0” may be used for indicating a UI element of the 2D layer and the number “1” may be used for indicating a UI element of the 3D layer. The tag information may also be “True” and “False”, and, for example, the “True” may be used for indicating a UI element of the 2D layer, and the “False” may be used for indicating a UI element of the 3D layer. This is not limited by the embodiments of the present invention.

120. Rendering processing is performed on the UI element of the 2D layer to acquire a data source for the UI element of the 2D layer, and rendering processing is performed on the UI element of the 3D layer to acquire a data source for the UI element of the 3D layer.

Alternatively, as another embodiment, the image processing device may process the UI element of the 2D layer by adopting a virtual monocular camera, to generate a buffer picture within a vision range of user's left and right eyes. Particularly, the UI element of the 2D layer may be photographed by adopting a virtual monocular camera, to generate a 2D buffer picture within the vision range of user's left and right eyes, that is, a data source for the UI element of the 2D layer. It should be understood that, in an embodiment of the present invention, the rendering processing performed on the UI element of the 2D layer by the image processing device may also be performed in any other manner in which the 2D buffer picture within the vision range of user's left and right eyes may be generated. This is not limited by the embodiments of the present invention.

Alternatively, as another embodiment, the image processing device may perform processing on the UI element of the 3D layer by adopting a visual binocular camera to generate buffer pictures for the user's left eye and right eye respectively. Particularly, the image processing device may photograph the UI element of the 3D layer by adopting a visual binocular camera and generate buffer pictures for user's left eye and right eye respectively, that is, a data source for the UI element of the 3D layer. It should be understood that, in an embodiment of the present invention, the rendering processing performed on the UI element of the 3D layer by the image processing device may be performed in any other manner in which the buffer pictures may be generated for the user's left eye and right eye respectively. For example, the image processing device may generate the buffer pictures with parallax for the user's left eye and right eye by adopting an algorithm in the prior art. This is not limited by the embodiments of the present invention.

130. The data source for the UI element of the 2D layer and the data source for the UI element of the 3D layer are combined to acquire a 2D and 3D fused data source.

Alternatively, as another embodiment, the image processing device may write the data source for the UI element of the 2D layer and the data source for the UI element of the 3D layer into a same data frame. For example, the image processing device may combine the buffer picture corresponding to the UI element of the 2D layer and the buffer picture corresponding to the UI element of the 3D layer in step 120, to acquire a combined image frame. It should be understood that the image processing device may also adopt any other manner, in which the data source for the UI element of the 2D layer and the data source for the UI element of the 3D layer are combined to acquire the 2D and 3D fused data source. This is not limited by the embodiments of the present invention.

In the prior art, the 2D part in the 2D and 3D fused scene may be realized through a simulation of the UI element of the 3D layer. If there is an angle between the model and a plane of z=0, a 2D display effect will be lost. Therefore, the display effect of the 2D and 3D fused scene can not be ensured.

Alternatively, as another embodiment, the image processing device may display a 2D and 3D fused scene based on the 2D and 3D fused data source.

For example, the image processing device may display the 2D and 3D fused scene based on the 2D and 3D fused data source by adopting a stereo display mechanism, such as lenticular lenses (Lenticular Lenses), parallax barries (Parallax Barries), directional backlight (Directional Backlight), etc. It should be understood that the manner adopted by the image processing device to display the 2D and 3D fused scene based on the 2D and 3D fused data source may also be any other implementation manner in the prior art, which is not limited by the embodiments of the present invention. Therefore, in the embodiments of the present invention, since the data source for the UI element of the 2D layer and the data source for the UI element of the 3D layer are acquired separately, the 2D display scene in the 2D and 3D fused scene is realized based on the data source for the UI element of the 2D layer, instead of based on a simulation of the UI element of the 3D layer in the prior art. Therefore, the 2D display scene is not limited by a position or an act of the UI element, thereby improving the display effect of the 2D and 3D fused scene.

In the embodiments of the present invention, the efficiency of rendering processing is enabled to be improved by acquiring a data source for a UI element of a 2D layer and a data source for a UI element of a 3D layer separately and then acquiring a 2D and 3D fused data source.

In addition, in the embodiments of the present invention, the limitation of the position of the UI element in the prior art can be avoided by acquiring a data source for a UI element of a 2D layer and a data source for a UI element of a 3D layer separately, thereby improving the flexibility of the UI design, end-to-end processing efficiency and engine rendering performance of an engine.

The embodiments of the present invention will be described below with reference to a specific example. FIG. 2 is a schematic flowchart of process of an image processing method of an embodiment of the present invention.

In step 210, an image processing device determines whether a UI element in a user scene belongs to a 2D layer or a 3D layer according to tag information.

Alternatively, the tag information may be a configuration file, or may be attribute information in an xml/html file for describing the UI element.

For example, the tag information may be tags of the 2D layer and the 3D layer. Taking a UI design in an html 5 format as an example, a Surface3D tag is added in a sub-node in a head (head) tag of the html 5, for recording an identification (Identification) of a UI element belonging to a 3D layer in the html 5. In rendering processing, the image processing device photographs the UI element corresponding to the ID recorded in the Surface3D tag by adopting a visual binocular camera.

An example of pseudocode of the Surface3D tag is as follows:

```
        <html xmlns= “http://www.xxx.org/xxxx/xhtml” >
        <head>
        <meta http-equiv= “content-type” content=”text/html;
        charset=UFT-8”>
        <Surface3D ElementldArray= “myCanvas”>
        <title> RichUx</title>
        </head>
        <body>
        <canvas id= “myCanvas” height= “100”
width= “50” src= “/i/ruchux/3dTest.dae”/>
        </body>
        </html>
```

Where in the sentence <html xmlns=“http://www.xxx.org/xxxx/xhtml”>, the “http://www.xxx.org/xxxx/xhtml” represents any website. It is just an exemplary illustration herein, rather than limiting the embodiments of the present invention.

In the sentence <Surface3D ElementIdArray=“myCanvas”>, the “myCanvas” represents an ID of a UI element of a 3D layer recorded in a Surface3D tag. It is just an exemplary illustration herein, rather than limiting the embodiments of the present invention.

It should be noted that the example of the pseudocode of the Surface3D tag herein is just for helping those skilled in the art to better understand the embodiments of the present invention, rather than for limiting the scope of the embodiments of the present invention. Those skilled in the art may perform, according to the provided example of the pseudocode, various equivalent changes or substitutions, which also fall in the protection scope of embodiments of the present invention.

If it is determined that, in step 210, the UI element belongs to the 3D layer according to the tag information, proceed to step 220. That is, buffer pictures are generated for left eye and right eye, respectively, through processing performed by a visual binocular camera.

If it is determined that, in step 210, the UI element belongs to the 2D layer according to the tag information, proceed to step 230. That is, a buffer picture within a vision range of the left and right eyes is generated by processing performed by a virtual monocular camera.

In step 240, the image processing device combines the corresponding buffer pictures of the UI element of the 3D layer in step 220 and the corresponding buffer picture of the UI element of the 2D layer in step 230, to acquire a 2D and 3D fused image frame.

For example, the image processing device may perform inverse processing on the corresponding buffer picture of the UI element of the 2D layer in step 230 and generate two pictures. And, the two pictures are combined with buffer pictures for the left eye and right eye, corresponding to the UI element of the 3D layer, respectively, to acquire the 2D and 3D fused image frame.

In step 250, the image processing device displays a 2D and 3D fused scene based on the 2D and 3D fused image frame acquired in step 240.

For example, the image processing device outputs the 2D and 3D fused image frame in step 240, and displays the 2D and 3D fused scene by adopting a stereo display mechanism, such as Lenticular Lenses, Parallax Barries, Directional Backlight, etc.

In the embodiments of the present invention, the efficiency of rendering processing can be improved by acquiring a data source for a UI element of a 2D layer and a data source for a UI element of a 3D layer separately and then acquiring a 2D and 3D fused data source.

In addition, in the embodiments of the present invention, the limitation of the position of the UI element in the prior art can be avoided by acquiring a data source for a UI element of a 2D layer and a data source for a UI element of a 3D layer separately, thereby improving the flexibility of UI design, end-to-end processing efficiency and rendering performance of an engine.

Furthermore, in the embodiments of the present invention, by acquiring a data source for a UI element of a 2D layer and a data source for a UI element of a 3D layer separately and then acquiring a 2D and 3D fused data source, there is no need to realize a 2D display by a simulation of a UI element of a 3D layer, thereby improving the display effect of the 2D and 3D fused scene.

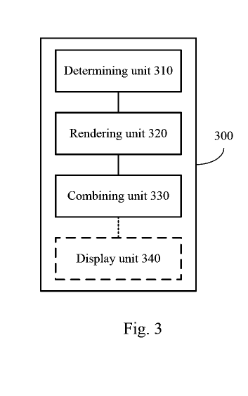

FIG. 3 is a block diagram of a structure of an image processing device of an embodiment according to the present invention. The image processing device 300 includes a determining unit 310, a rendering unit 320 and a combining unit 330.

The determining unit 310 determines a UI element of a 2D layer and a UI element of a 3D layer in a user scene. The rendering unit 320 performs rendering processing on the UI element of the 2D layer to acquire a data source for the UI element of 2D layer, and performs rendering processing on the UI element of the 3D layer to acquire a data source for the UI element of the 3D layer. The combining unit 330 combines the data source for the UI element of the 2D layer and the data source for the UI element of the 3D layer to acquire a 2D and 3D fused data source.

In the embodiments of the present invention, the efficiency of rendering processing can be improved by acquiring a data source for a UI element of a 2D layer and a data source for a UI element of a 3D layer separately and then acquiring a 2D and 3D fused data source.

In addition, in the embodiments of the present invention, the limitation of the position of the UI element in the prior art can be avoided by acquiring a data source for a UI element of a 2D layer and a data source for a UI element of a 3D layer separately, thereby improving the flexibility of UI design, end-to-end processing efficiency and rendering performance of an engine.

Alternatively, as an embodiment, the determining unit 310 may determines the UI element of the 2D layer and the UI element of the 3D layer in the user scene according to tag information, wherein the tag information is used for indicating whether a UI element in the user scene belongs to a 2D layer or a 3D layer.

Alternatively, as another embodiment, the tag information may be a configuration file, or may be attribute information of an xml/html file for describing the UI element.

Alternatively, as another embodiment, the rendering unit 320 may perform the processing on the UI element of the 2D layer by using a virtual monocular camera, to generate a buffer picture within a vision range of user's right and left eyes.

Alternatively, as another embodiment, the rendering unit 320 may perform the processing on the UI element of the 3D layer by using a visual binocular camera, to generate buffer pictures for user's left eye and right eye, respectively.

Alternatively, as another embodiment, the combining unit 330 may write the data source for the UI element of the 2D layer and the data source for the UI element of the 3D layer into a same data frame.

Alternatively, as another embodiment, the image processing device may further include a display unit 340. The display unit 340 may display a 2D and 3D fused scene based on the 2D and 3D fused data source.

In the embodiments of the present invention, by acquiring a data source for a UI element of a 2D layer and a data source for a UI element of a 3D layer separately and then acquiring a 2D and 3D fused data source, there is no need to realize a 2D display by a simulation of a UI element of a 3D layer, thereby improving the display effect of the 2D and 3D fused scene.

Other functions and operations of the image processing device 300 may be referred to the processes of the method embodiments in FIG. 1 and FIG. 2, which are not described repeatedly herein to avoid repetition.

In the embodiments of the present invention, the efficiency of rendering processing can be improved by acquiring a data source for a UI element of a 2D layer and a data source for a UI element of a 3D layer separately and then acquiring a 2D and 3D fused data source.

In addition, in the embodiments of the present invention, the limitation of the position of the UI element in the prior art can be avoided by acquiring a data source for a UI element of a 2D layer and a data source for a UI element of a 3D layer separately, thereby improving the flexibility of UI design, end-to-end processing efficiency and rendering performance of an engine.

The persons of ordinary skills in the art may realize that the units and steps of algorithm of the respective examples, described with reference to the embodiments disclosed in the text, can be accomplished by electronic hardware, or a combination of computer software and electronic hardware. Whether these functions are executed by means of hardware or software depends on a specific application and a design constraint condition of the technical solutions. Professional technical personnel may accomplish the described functions by adopting a different method for each specific application, but this kind of accomplishment should not go beyond the scope of the present invention.

Those skilled in the art may understand clearly that, for convenience and simplicity of description, specific working processes of the above-described systems, apparatus and units may be referred to corresponding processes in the aforementioned embodiments of the methods, and will not be described repeatedly herein.

In several embodiments provided by the present application, it should be understood that disclosed systems, apparatus and methods may be implemented by other manners For example, the embodiments of the apparatus described above are just illustrative. For example, division of the units is just a kind of division according to logical functions, and there may be other division manners for practical implementations. For example, multiple units or components may be combined or integrated into another system, or some features may be neglected or may not be performed. In addition, the shown or discussed mutual coupling or direct coupling or communication link may be an indirect coupling or communication link through some interfaces, apparatus or units, which may be in an electrical form, a mechanical form or in other forms.

The units described as separated parts may be, or may not be, physically separated, and the parts shown as units may be, or may not be, physical units, which may be located in one place or distributed to multiple network elements. Part or all units therein may be selected, according to an actual need, to implement the objective of solutions provided in the present invention.

In addition, the respective functional units in the respective embodiments of the present invention may be integrated into one processing unit, or the respective units may exist separately and physically, or, two or more units may be integrated into one unit.

If the function is implemented in the form of a software functional unit and is sold or used as an independent product, the function may be stored in a computer readable storage medium. Based on this understanding, the spirit, or the parts that make contributions to the prior art, of the technical solution in the present invention may be embodied in the form of a software product. The computer software product is stored in a storage medium, and includes a number of instructions that enable a computer device (may be a personal computer, a server, or a network device) to execute all or part of steps of the method described in the respective embodiments of the present invention. The preceding storage mediums includes various mediums that can store program codes, such as, a U disk, a removable hard disk, a read-only memory (Read-Only Memory, ROM), a random access memory (Random Access Memory, RAM), a magnetic disk, an optical disk, or the like.

The foregoing descriptions are merely specific embodiments of the invention, rather than limiting the protection scope of the invention. It is easy for any one skilled in the art to conceive changes or substitutions within the technical scope disclosed by the invention, and the changes or substitutions should fall in the protection scope of the invention. Therefore, the protection scope of the present invention should be defined by the claims.

What is claimed is:

1. An image processing method, comprising:
determining a User Interface UI element of a Two-Dimensional (2D) layer and a UI element of a Three-Dimensional (3D) layer in a user scene;
performing rendering processing on the UI element of the 2D layer to acquire a data source for the UI element of the 2D layer, and performing rendering processing on the UI element of the 3D layer to acquire a data source for the UI element of the 3D layer; and
combining the data source for the UI element of the 2D layer and the data source for the UI element of the 3D layer, to acquire a 2D and 3D fused data source.

2. The method of claim 1, wherein the determining a User Interface UI element of a Two-Dimensional (2D) layer and a UI element of a Three-Dimensional (3D) layer in a user scene comprises:
determining the UI element of the 2D layer and the UI element of the 3D layer in the user scene according to tag information, wherein the tag information is used for indicating whether a UI element in the user scene belongs to one of a 2D layer and a 3D layer.

3. The method of claim 2, wherein the tag information is one of a configuration file and attribute information in one of an extensible markup language (xml) and a hypertext markup language (html) file for describing the UI element.

4. The method of claim 1, wherein the performing rendering processing on the UI element of the 2D layer to acquire a data source for the UI element of the 2D layer comprises:
processing the UI element of the 2D layer by using a virtual monocular camera, to generate a buffer picture within a vision range of user's right and left eyes.

5. The method of claim 1, wherein the performing rendering processing on the UI element of the 3D layer to acquire a data source for the UI element of the 3D layer comprises:
processing the UI element of the 3D layer by using a visual binocular camera, to generate buffer pictures for user's left eye and right eye, respectively.

6. The method of claim 1, wherein the combining the data source for the UI element of the 2D layer and the data source for the UI element of the 3D layer comprises:
writing the data source for the UI element of the 2D layer and the data source for the UI element of the 3D layer into a same data frame.

7. The method of claim 1, the method further comprising:
displaying a 2D and 3D fused scene based on the 2D and 3D fused data source.

8. An image processing device, comprising:
a determining unit, configured to determine a User Interface (UI) element of a Two-Dimensional (2D) layer and a UI element of a Three-Dimensional (3D) layer in a user scene;
a rendering unit, configured to perform rendering processing on the UI element of the 2D layer to acquire a data source for the UI element of the 2D layer, and perform rendering processing on the UI element of the 3D layer to acquire a data source for the UI element of the 3D layer; and
a combining unit, configured to combing the data source for the UI element of the 2D layer and the data source for the UI element of the 3D layer, to acquire a 2D and 3D fused data source.

9. The device of claim 8, wherein the determining unit is configured to determine the UI element of the 2D layer and the UI element of the 3D layer in the user scene according to tag information, and the tag information is used for indicating whether a UI element in the user scene belongs to one of a 2D layer and a 3D layer.

10. The device of claim 9, wherein the tag information is one of a configuration file and attribute information in one of an extensible markup language (xml) and a hypertext markup language (html) file for describing the UI element.

11. The device of claim 8, wherein the rendering unit is configured to process the UI element of the 2D layer by using a virtual monocular camera, to generate a buffer picture within a vision range of user's right and left eyes.

12. The device of claim 8, wherein the rendering unit is configured to process the UI element of the 3D layer by using a visual binocular camera, to generate buffer pictures for user's left eye and right eye, respectively.

13. The device of claim 8, wherein the combining unit is configured to write the data source for the UI element of the 2D layer and the data source for the UI element of the 3D layer into a same data frame.

14. The device of claim 8, wherein the device further comprises a display unit for displaying a 2D and 3D fused scene based on the 2D and 3D fused data source.
